(19) United States
(12) Patent Application Publication
(10) Pub. No.: US 2011/0268318 A1
(43) Pub. Date: Nov. 3, 2011

(54) PHOTO DETECTING APPARATUS AND SYSTEM HAVING THE SAME

(76) Inventors: Kyung-Il KIM, Anyang-si (KR); Tae-Chan KIM, Yongin-si (KR); Yong-Bin KIM, Yongin-si (KR); Dong-Joon LEE, Masan-si (KR)

(21) Appl. No.: 13/074,655

(22) Filed: Mar. 29, 2011

(30) Foreign Application Priority Data
Apr. 28, 2010 (KR) 10-2010-0039288

(51) Int. Cl. G06K 9/00

(52) U.S. Cl. 382/103

(57) ABSTRACT

A photo detecting apparatus may include a signal processing unit, a control register unit, and a register data changing unit. The signal processing unit is configured to process electric signals converted from incident light to generate image data. The control register unit supplies a set value to the signal processing unit, the set value controlling operation of the signal processing unit. The control register unit stores a first set value supplied through a first bus, the first set value corresponding to an initial set value based on a decoded external control signal. In addition, the register data changing unit supplies a second set value to the control register unit through a second bus, separate from the first bus, when the first set value is to be changed.

### CROSS-REFERENCE TO RELATED APPLICATIONS

This application claims priority under 35 U.S.C.§119 to Korean Patent Application No. 10-2010-0039288, filed on Apr. 28, 2010, in the Korean Intellectual Property Office, and entitled: “Photo Detecting Apparatus and System Having the Same,” which is incorporated by reference herein in its entirety.

### BACKGROUND

1. Field

Example embodiments relate generally to image devices. More particularly, embodiments of the inventive concept relate to a photo detecting apparatus and a system having the photo detecting apparatus.

2. Description of the Related Art

A photo detecting apparatus is a device for converting image or distance information provided by optical information to electric signals. Many attempts have been tried for obtaining more detailed and accurate information.

The photo detecting apparatus includes various control circuits. Thus, various set values are required to drive the control circuits. These set values are stored in control registers and are fixed, since they are determined based on hardware. Thus, the set values cannot be changed without modifying the hardware. Therefore, when these set values need to be changed, the hardware must be changed, leading to increased time and cost.

### SUMMARY

Some example embodiments provide a photo detecting apparatus capable of changing set values stored in a control register without modifying hardware.

Some example embodiments provide a system including the photo detecting apparatus.

According to some example embodiments, a photo detecting apparatus includes a signal processing unit, a control register unit, and a register data changing unit. The signal processing unit processes electric signals converted from incident light to generate image data. The control register unit supplies a set value for controlling signal processing unit to the signal processing unit and stores a first set value supplied through a first bus. Te first set value corresponds to an initial set value based on a decoded external control signal. The register data changing unit supplies a second set value through a second bus, separate from the first bus, when the first set value is to be changed.

In some embodiments, the control register unit may include at least one selection unit and at least one register bank. The at least one selection unit may be configured to select one of the first bus and the second bus in response to a bus selection signal provided from the register data changing unit. The at least one register bank may store one of the first set value and the second set value according to the selection of the selection unit.

The register data changing unit may include a non-volatile memory and a memory control circuit. The non-volatile memory may store the second set values and commands associated with the second set values. The memory control circuit may read the commands to control the non-volatile memory for storing the second set value in the at least one register bank, and output the bus selection signal to the selection unit.

In some embodiments, the non-volatile memory may be one of a flash memory, an Electrically Erasable Programmable Read-Only Memory (EEPROM), a Phase Change Random Access Memory (PRAM), a Resistance Random Access Memory (RRAM) and a Magnetic Random Access Memory (MRAM).

The at least one selection unit may include a plurality of multiplexers. Each multiplexer may select one of a first register address associated with the first set value and a second register address associated with the second set value in response to the bus selection signal. In addition, each multiplexer may select one of a first register data associated with the first set value and a second register data associated with the second set value.

The at least one register bank may store the selected data at a location designated by the selected address.

The selection unit may select the first bus when the bus selection signal is a first level, and may select the second bus when the bus selection signal is a second level.

In some embodiments, the control register may include a plurality of selection units and a plurality of register banks. Each selection unit may select one of the first bus and the second bus in response to a corresponding plurality of bus selection signals provided from the register data changing unit. In addition, each register bank may store one of the first set value and the second set value according to the selection of a corresponding selection unit.

The plurality of bus selection signals may be sequentially applied to the plurality of selection units.

The plurality of bus selection signals may be simultaneously applied to the plurality of selection units.

The plurality of bus selection signals may be independently generated.

Each selection unit may provide one of the first set value and the second set value in response to a corresponding plurality of bus selection signals to different components of the signal processing unit.

In some embodiments, the photo detecting apparatus may further include a photoelectric converting unit configured to convert incident light to electric signal.

The photoelectric converting unit may include a plurality of unit pixels.

Each of the unit pixels may be one of a 3-transistor structure, a 4-transistor structure and a photogate-type.

According to other example embodiments, a system includes a processor and a photo detecting apparatus communicating with the processor, e.g., through a bus. The photo detecting apparatus includes a signal processing unit, a control register unit, and a register data changing unit. The signal processing unit is configured to process electric signals converted from incident light to generate image data. The control register unit supplies a set value for controlling the signal processing unit to the signal processing unit and stores a first set value through a first bus. The first set value corresponds to an initial set value based on a decoded external control signal. The register data changing unit is configured to supply a second set value through a second bus, separate from the first bus, when the first set value is to be changed.

The signal processing unit may include an analog double sampling unit to calculate difference between an analog reset voltage and an analog data voltage. The analog reset voltage may represent a reset component and the analog data voltage may represent a signal corresponding to the incident light.

The photo detecting apparatus may include a pixel array and the signal processing unit may perform analog-digital conversion for each column of the pixel array.

In some embodiments, the signal processing unit may include an analog to digital converting unit and a digital double sampling unit. The analog to digital converting unit may convert an analog signal associated with reset component and an analog signal associated with signal component into two digital signals, respectively. The digital double sampling unit may then calculate a difference between the two digital signals.

The photo detecting apparatus may include a pixel array and the signal processing unit may be configured to perform analog-digital conversion for each column of the pixel array.

In some embodiments, the photo detecting apparatus may include a pixel array and the signal processing unit may include a correlated double sampling unit, a multiplexer, and an analog-digital converting unit. The correlated double sampling unit may be configured to perform an analog double sampling on an analog reset voltage representing a reset component and an analog data voltage representing a signal corresponding to the incident light for calculating a difference between the analog reset voltage and the analog data voltage. In addition, the correlated double sampling unit may be configured to output an analog voltage corresponding to an effective component for each column. The multiplexer may sequentially output the analog voltage corresponding to the effective signal component for each column in the pixel array. The analog-digital converting unit may be configured to convert an output of the multiplexer into a digital signal.

According to other example embodiments, a control system for use with a photo detecting apparatus may include a controller, a first bus, and a second bus, separate from the first bus. The controller may be configured to provide a set value to a signal processing unit that processes electrical signals converted from incident light to generate image data, the signal processing unit operating in accordance with the set value. The first bus may supply a first set value corresponding to an initial set value based on a decoded external control signal to the controller. The second bus, separate from the first bus, may supply a second set value, different from the first set value, to the controller.

The controller may include at least one selection unit which provides one of the first set value and the second set value in response to a bus selection signal.

The controller may include a plurality of selection units, each selection unit providing one of the first set value and the second set value in response to a corresponding plurality of bus selection signals to different components of the signal processing unit.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a block diagram of a photo detecting apparatus according to embodiment of the inventive concept.

FIG. 2 illustrates a block diagram of a register changing unit in the apparatus of FIG. 1 according to embodiment of the inventive concept.

FIG. 3 illustrates a block diagram of an interface unit in the apparatus of FIG. 1 according to embodiment of the inventive concept.

FIG. 4 illustrates a block diagram of a control register unit in the apparatus of FIG. 1 according to embodiment of the inventive concept.

FIG. 5 illustrates a timing diagram of operation of the photo detecting apparatus of FIG. 1 according to embodiment of the inventive concept.

FIG. 6 illustrates a diagram of an example of a photoelectric converting unit and an example of a signal processing unit in the photo detecting apparatus of FIG. 1.

FIG. 7 illustrates a diagram of another example of a photoelectric converting unit and an example of a signal processing unit in the photo detecting apparatus of FIG. 1.

FIG. 8 illustrates a diagram of another example of a photoelectric converting unit and an example of a signal processing unit in the photo detecting apparatus of FIG. 1.

FIG. 9 illustrates a diagram of another example of a photoelectric converting unit and an example of a signal processing unit in the photo detecting apparatus of FIG. 1.

FIG. 10 illustrates a block diagram of another photo detecting apparatus according to an embodiment of the inventive concept.

FIG. 11 illustrates a diagram of a system comprising the photo detecting apparatus of FIG. 1.

### DETAILED DESCRIPTION OF THE EMBODIMENTS

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

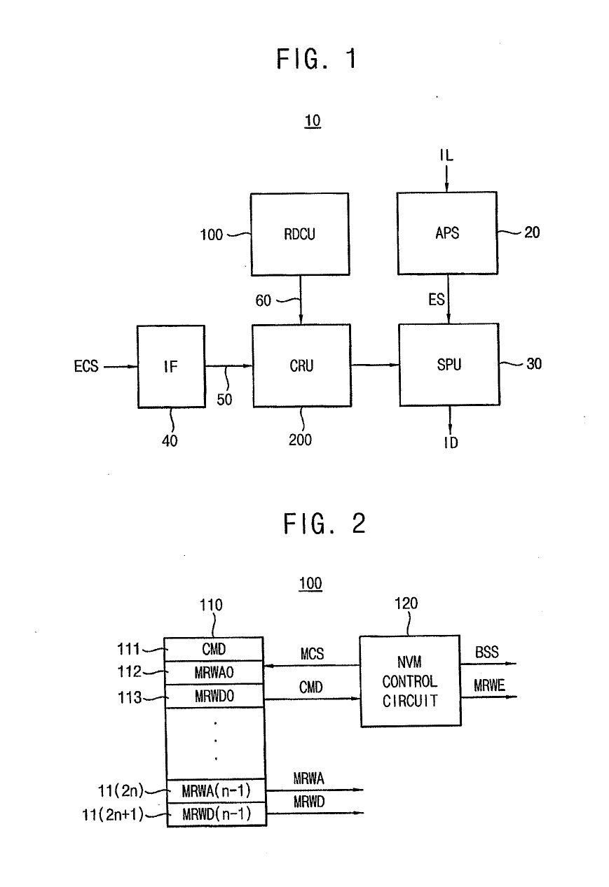

FIG. 1 illustrates a block diagram of a photo detecting apparatus 10 according to some example embodiments. Referring FIG. 1, the photo detecting apparatus 10 may include a photoelectric converting unit 20, a signal processing unit (SPU) 30, an interface unit (IF) 40, a register data changing unit (RDCU) 100, and a control register unit (CRU) 200.

The photoelectric converting unit (or active pixel array) 20 converts incident light IL to an electric signal ES. The incident light IL is light from an object to be imaged, e.g., a flower or a person, onto the active pixel array 20 through an optical lens. The photoelectric converting unit 20 may include active pixel array that has a plurality of unit pixels. Each of the unit pixels may be one of, e.g., a 3-transistor structure, a 4-transistor structure and photogate type.

The signal processing unit 30 processes the electrical signal ES to generate image data ID. The image data ID is output externally to the photo detecting apparatus 10 via buffers (not illustrated) or the like. As will be described later, the signal processing unit 30 may include a timing controller, a correlated double sampling unit, and an analog-digital converting unit. The timing controller, the correlated double sampling unit, and the analog-digital converting unit of the signal processing unit 30 may start operation with reference to set values (data) stored in the control register unit 200.

The interface unit 40 decodes an external control signal ECS to provide the decoded control signal to the control register unit 200 through a first bus 50. The control register unit 200 supplies set values to the signal processing unit 30, the set value controlling the signal processing unit 30. The control register unit 200 stores a first set value that corresponds to an initial set value based on the decoded external control signal. The first set value is the initial set value provided for controlling the signal processing unit 30 to control the signal processing unit 30 when the photo detecting apparatus is turned on and reset.

The register data changing unit 100 supplies a second set value to the control register unit 200 through a second bus 60, separate from the first bus 50, when the first set value needs to be changed.

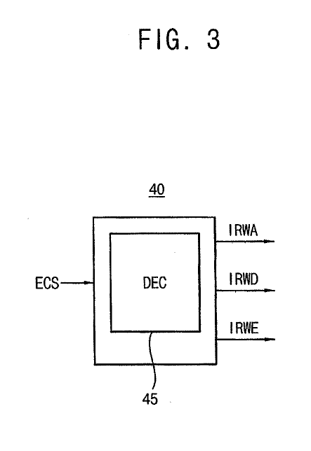

FIG. 2 illustrates a block diagram of the register data changing unit 100 in FIG. 1 according to some example embodiments. Referring FIG. 2, the register data changing unit 100 may include a non-volatile memory 110 and a memory control circuit 120.

The non-volatile memory 110 may include a plurality of areas 111, 112, 113, . . . , 11(2n), 11(2n+1), where n is an integer equal to or greater than two. A command CMD is stored in area 111, and second register addresses MRWA0, . . . , MRWA(n−1) and second register data MRWD0, . . . , MRWD(n−1) are stored in pairs in areas 112, 113, . . . , 11(2n), 11(2n+1), respectively. The memory control circuit 120 reads out the command CMD stored in the non-volatile memory 110, and provides a bus selection signal BSS and a second register enable signal MRWE to the control register unit 200 according to the command CMD. In addition, the memory control circuit 120 provides a memory control signal MCS to the non-volatile memory such that at least one of the second register data MRWD0, . . . , MRWD(n−1) associated with the second set values is stored at a location designated by at least one of the second register addresses MRWD0, . . . , MRWD(n−1). The command CMD may include information about a usage of the second register data MRWD0, . . . , MRWD(n−1) associated with the second set values, a schedule of the data being used, and an amount of data. In some embodiments, the non-volatile memory 110 may be one of a flash memory, an electrically erasable programmable read-only memory (EEPROM), a phase change random access memory (PRAM) which use phase change materials, a resistance random access memory (RRAM) which use transition metal oxides having variable resistance properties or the like, and a magnetic random access memory (MRAM) which use ferromagnetic materials.

FIG. 3 illustrates a block diagram of the interface unit 40 in the apparatus of FIG. 1 according to some example embodiments. Referring FIG. 3, the interface unit 40 may include a decoder (DEC) 45. The decoder 45 decodes an external control signal ECS to provide first register addresses IRWA0, . . . , IRWA(n−1), first register data IRWD0, . . . , IRWD(n−1), and first register enable signal IRWE associated with the first set value for the control register unit 60. In other words, the first register data IRWD0, . . . , IRWD(n−1) are stored at the locations designated by the first register addresses IRWA0, . . . , IRWA(n−1).

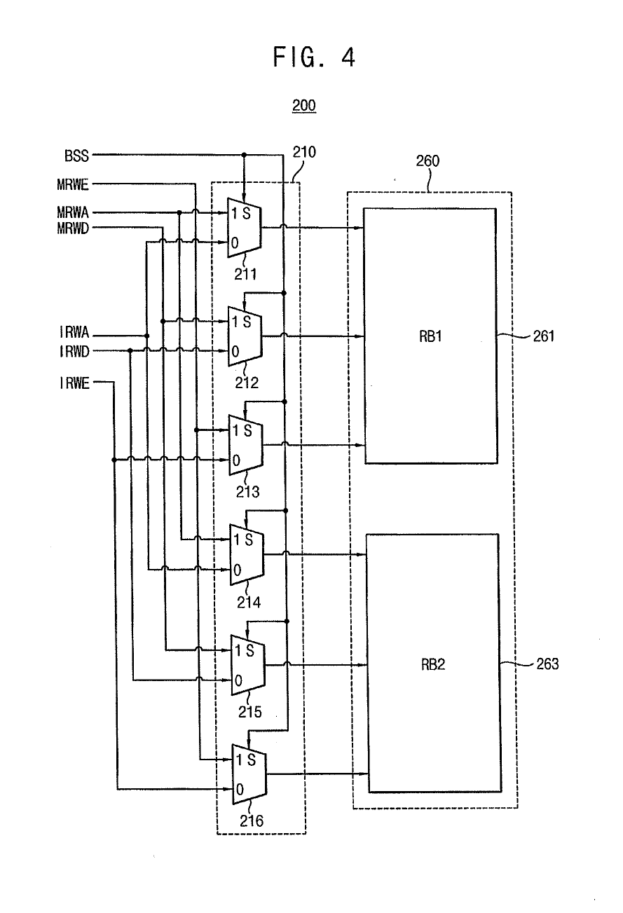

FIG. 4 illustrates a block diagram of the control register unit 200 in FIG. 1 according to some example embodiments. Referring FIG. 4, the control register unit 200 may include a selection unit 210 and at least one register bank 260. In FIG. 4, the at least one register bank may include register banks 261, 263. Although not illustrated in FIG. 4, each of the register banks 261 and 263 may include a plurality of registers.

The selection unit 210 may include a plurality of multiplexers 211, 212, 213, 214, 215, and 216. The bus selection signal BSS provided by the register data changing unit 100 is applied to a control terminal S of each of the multiplexers 211, 212, 213, 214, 215, and 216.

The multiplexer 211 selects the first register address IRWA or the second address MRWA according to the bus selection signal BSS to provide one of the two register addresses for the register bank 261. The multiplexer 212 selects one of the first register data IRWD and the second register data MRWD according to the bus selection signal BSS to provide one of the two register data for the register bank 261. The multiplexer 213 selects one of the first register enable signal IRWE and the second register enable signal MRWE according to the bus selection signal BSS to provide one of the two register enable signals for the register bank 261.

The multiplexer 214 selects one of the first register address IRWA and the second register address MRWA according to the bus selection signal BSS to provide one of the two register addresses for the register bank 263. The multiplexer 215 selects one of the first register data IRWD and the second register data MRWD according to the bus selection signal BSS to provide one of the two register data for the register bank 263. The multiplexer 216 selects one of the first register enable signal IRWE and the second register enable signal MRWE according to the bus selection signal BSS to provide one of the two register enable signals for the register bank 263.

For example, when the bus selection signal BSS is a logic low level, the register bank 261 may be enabled by the first register enable signal IRWE and the first register data IRWD may be written in the register bank 261 at a location designated by the first register address IRWA. In addition, the register bank 263 may be enabled by the first register enable signal IRWE and the first register data IRWD may be written in the register bank 263 at a location designated by the first register address IRWA. The first register data IRWD stored in the first register bank 261 and the second register bank 263 may represent different first set values with respect to each other.

For example, when the bus selection signal BSS is a logic high level, the register bank 261 may be enabled by the second register enable signal MRWE and the second register data MRWD may be written in the register bank 261 at a location designated by the second register address MRWA. In addition the register bank 263 may be enabled by the second register enable signal MRWE and the second register data MRWD may be written in the register bank 263 at a location designated by the second register address MRWA. The second register data MRWD stored in the first register bank 261 and the second register bank 263 may represent different second set values with respect to each other. Alternatively, the data may be stored in the register banks 261 and 263 by adjusting a time when the bus selection signal BSS is applied to the selection unit 210.

In other words, the photo detection apparatus 10 according to example embodiments includes the register data changing unit 100 and the control register unit 200 to store data in the register banks 261 and 263 using the bus selection signal BSS. In this way, the set values (or the data) stored in the register banks 261 and 263 may be changed.

As described above, the signal processing unit 30 operates based on the first set value or the second set value by referring to a designated address because the first set value or the second set value is stored at the designated address in the register banks 261 and 263.

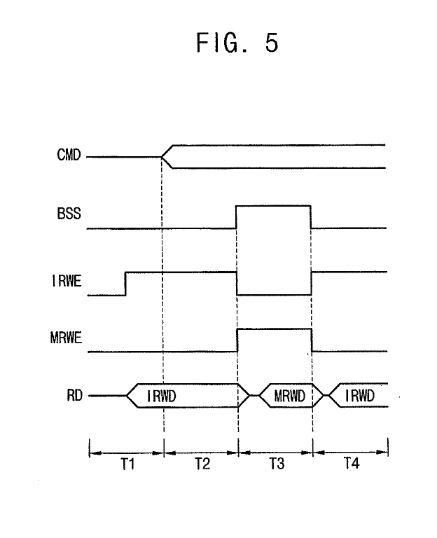

FIG. 5 illustrates a timing diagram of an operation of the photo detecting apparatus of FIG. 1 according to some example embodiments. Referring to FIGS. 1 to FIG. 5, operation of the photo detecting apparatus will be described below.

In FIG. 5, the command CMD, the bus selection signal BSS, the first register enable signal IRWE, the second register enable signal MRWE and a register data RD (or set value) stored in at least one register banks 261 and 263 are illustrated.

During a time interval T1, when the bus selection signal BSS is a logic low level and the first register enable signal IRWE is activated, the first register data IRWD is stored as the register data RD in the register banks 261 and 263. During a time interval T2, because the bus selection signal BSS is a logic low level according to the command CMD and the first register enable signal IRWE is activated, the first register data IRWD is stored as the register data RD in the register banks 261 and 263. During a time interval T3, when the bus selection signal BSS is a logic high level according to the bus selection signal BSS and the second register enable signal is activated, the second register data MRWD is stored as the register data RD in the register banks 261 and 263. During a time interval T4, when the bus selection signal BSS is a logic low level again according to the bus selection signal BSS and the first register enable signal IRWE is activated, the first register data IRWD is stored as the register data RD in the register banks 261 and 263.

During the time interval T1, for example, the signal processing unit 30 is controlled by the first register data IRWD when the photo detecting apparatus 10 is turned on. During the time interval T2, the signal processing unit 30 is controlled by the first register data IRWD according to the command CMD. During the time interval T3, the signal processing unit 30 is controlled by the second register data MRWD according to the command CMD. During the time interval T4, the signal processing unit 30 is controlled by the first register data IRWD according to the command CMD. That is, during the time interval T3, the register data RD stored in the register banks 261 and 263 is changed from the first register data IRWD to the second register data MRWD, without modifying hardware.

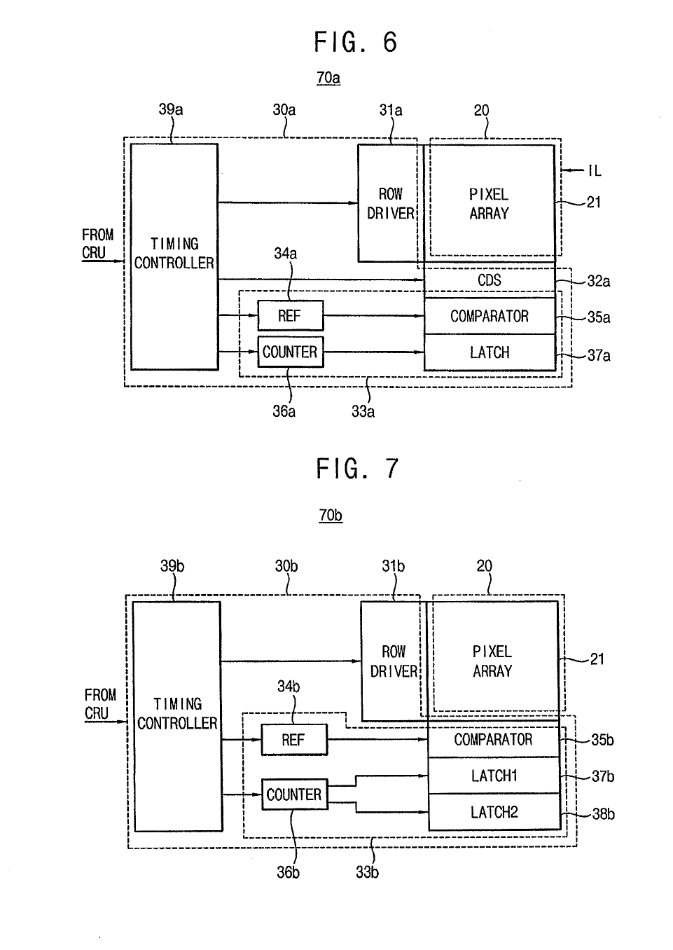

FIG. 6 illustrates a block diagram of an example of the photoelectric converting unit and the signal processing unit in the photo detecting apparatus of FIG. 1. In FIG. 6, the interface unit 40, the register changing unit 100, and the control register unit 200 are not illustrated for clarity. Referring FIG. 6, the photo detecting apparatus 70a includes the photoelectric converting unit 20 and a signal processing unit 30a.

The photoelectric converting unit 20 converts incident light IL to an electric signal. The photoelectric converting unit 20 may include a pixel array 21, in which unit pixels are arranged in matrix form.

The signal processing unit 30a includes a row driver 31a, a correlated double sampling (CDS) unit 32a, an analog-digital converting (ADC) unit 33a, and a timing controller 39a. The ADC unit 33a includes a reference signal generator 34a, a comparator 35a, a counter 36a, and a latch unit 37a. The signal processing unit 30a is controlled by the first set value (the first register data IRWD) or the second set value (the second register data MRWD) stored in the register banks. The first set value (the first register data IRWD) or the second set value (the second register data MRWD) is provided according to the bus selection signal BSS. The timing controller 39a, the reference signal generator 34a, and the counter 36a are controlled by the set values (the register data).

The row driver 31a is connected to each row of the pixel array 21, and generates a driving signal which drives each row of the pixel array 21. For example, the row driver 31a may drive a plurality of unit pixels with a row as a unit.

The CDS unit 32a uses capacitors, switches or the like, for performing analog double sampling (ADS) by calculating a difference between an analog reset voltage and an analog data voltage. The analog reset voltage represents a reset component and the analog data voltage represents a signal component of the incident light IL. The CDS unit 32a may include a plurality of CDS circuits. Each of the CDS circuits may be connected to a column of the pixel array 21. In addition, the CDS unit 32a may output an analog voltage corresponding to the effective signal component for each column of the pixel array 21 to the ADC unit 33a.

The ADC unit 33a converts the analog voltage corresponding to the effective signal component to a digital voltage. The reference signal generator 34a generates a reference signal, i.e. a ramp signal having a constant slope, and provides the ramp signal as the reference signal for the comparator 35a. The comparator 35a compares the analog voltage provided by the CDS unit 32a with the reference signal provided by the reference signal generator 34a, and output comparison signals having a transition time according to the effective signal component. The counter 36a generates a count signal to provide the count signal for the latch unit 37a. The latch unit 37a includes a plurality of latch circuits, with each latch circuit being connected to a column of the pixel array 21. In addition, the latch unit 37a latches the count signals for each column of the pixel array 21 in response to the transition of the comparison signal.

The timing controller 39a may control the driving timing of the row driver 31a, the CDS unit 32a, and the ADC unit 33a. In particular, the timing controller 39a may provide a timing signal and a control signal for the row driver 31a, the CDS unit 32a, and the ADC unit 33a.

FIG. 7 illustrates a block diagram of another example of the photoelectric converting unit and an example of the signal processing unit in the photo detecting apparatus of FIG. 1. In FIG. 7, the interface unit 40, the register changing unit 100, and the control register unit 200 are not illustrated for clarity. Referring FIG. 7, a photo detecting apparatus 70b includes the photoelectric converting unit 20 and a signal processing unit 30b.

The signal processing unit 30b includes a row driver 31b, an ADC unit 33b, and a timing controller 39b. The ADC unit 33b includes a reference signal generator 34b, a comparator 35b, a counter 36b, a first latch unit 37b, and a second latch unit 38b. The signal processing unit 30b is controlled by either the first set value (the first register data IRWD) or the second set value (the second register data MRWD), which are stored in the register banks 261, 263 of FIG. 4. The first set value (the first register data IRWD) or the second set value (the second register data MRWD) is provided according to the bus selection signal BSS, for a set value (register data) to control a timing controller 39b, the reference signal generator 34b, and the counter 36b.

The photo detecting apparatus 70b performs digital double sampling (DDS) by using the first latch unit 37b and the second latch unit 38b. Namely, the first latch unit 37b and the second latch unit 38b convert two analog signals to digital signals, respectively. One of the two analog signals has a reset component, and the other one has a signal component based on the incident light IL. In addition, the photo detecting apparatus 70b calculates difference between the two digital signals to represent effective signal component.

The pixel array 21 outputs a first analog voltage representing the reset component and a second analog voltage representing an image signal component. In first sampling step, the comparator 35b compares the first analog voltage and a reference signal provided by the reference signal generator 34b to output the comparison signal having transition times according to the reset component, for each column. A count signal from the counter 36b is provided for each of the latch circuits in the first latch unit 37b. In addition, each latch circuit latches the count signal from the counter at transition time of the count signal corresponding to the latch circuit. In addition, each of the latch circuits store the digital signal corresponding to the reset component.

In second sampling step, the comparator 35b compares the second analog voltage representing the image signal component and the reference signal provided by the reference signal generator 34b to output the comparison signal having transition times according to the image signal component, for each column. The second latch unit 38b latches the count signal provided by the counter 36b to store the digital signal corresponding to the image signal component. The latching is performed at the transition time of each of the comparison signals. The digital signals stored in the first latch unit 37b and the second latch unit 38b are provided to an internal circuit performing logical operations, then the effective image signal component as an image data can be calculated. Digital double sampling is performed as described above.

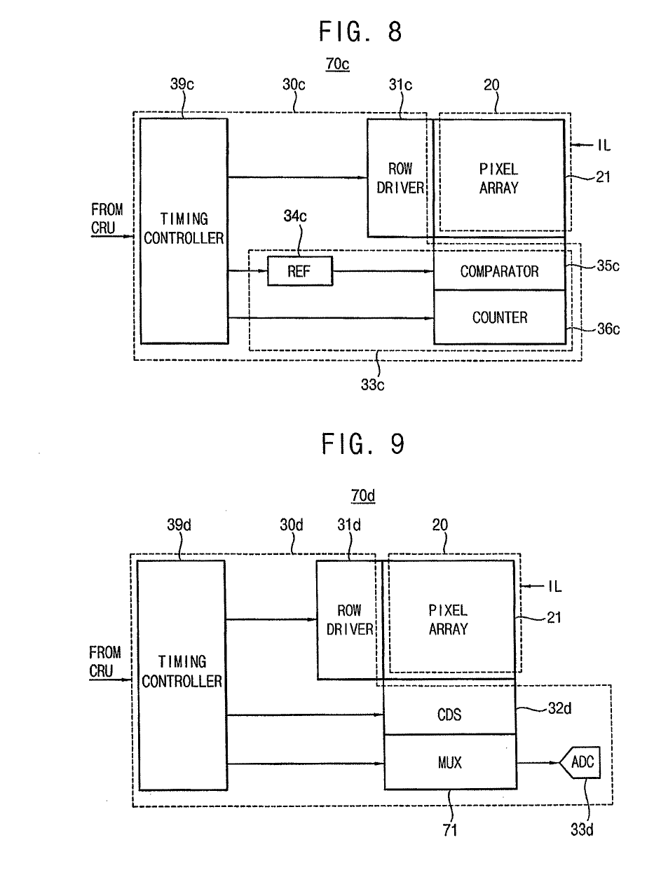

FIG. 8 illustrates a diagram of another example of the photoelectric converting unit and an example of the signal processing unit in the photo detecting apparatus of FIG. 1. In FIG. 8, the interface unit 40, the register changing unit 100, and the control register unit 200 are not illustrated for clarity. Referring FIG. 8, a photo detecting apparatus 70c includes the photoelectric converting unit 20 and a signal processing unit 30c.

The signal processing unit 30c includes a row driver 31c, an ADC unit 33c, and a timing controller 39c. The ADC unit 33c includes a reference signal generator 34c, a comparator 35c, and a counter 36c. The signal processing unit 30c is controlled by one of the first set value (the first register data IRWD) and the second set value (the second register data MRWD), which are stored in the register banks 261, 263. One of the first set value (the first register data IRWD) and the second set value (the second register data MRWD) is provided for controlling the timing controller 39c, the reference signal generator 34c, and the counter 36c. One of the first set value (the first register data IRWD) and the second set value (the second register data MRWD) is provided as a set value (register data) according to the bus selection signal BSS.

The analog signal provided by the pixel array 21 is converted to digital signal by ADC unit 33c, which includes the comparison unit 35c and the counter 36c. The comparison unit 35c and the counter 36c may includes a plurality of comparators and a plurality of counters to perform parallel processing of the analog signals provided by the pixel array 21 by column. Since the counter 36c includes a plurality of counters, each connected to a column of the pixel array 21, the photo detecting apparatus 70c may perform high-speed operation. The photo detecting apparatus 70c may also perform digital double sampling.

The pixel array 21 may output the first analog signal representing the reset component and the second analog signal representing the image signal component, respectively. The ADC unit 33c including the comparison unit 35c and the counter 36c may digitally perform correlated double sampling, i.e. digital double sampling.

FIG. 6 illustrates an example of the photo detecting apparatus 70a performing analog double sampling, and FIG. 7 and FIG. 8 respectively illustrate examples of the photo detecting apparatus 70b, 70c performing digital double sampling. The photo detecting apparatus may perform analog correlated double sampling or dual correlated double sampling. The analog correlated double sampling may be performed by using an analog circuit such as a switched capacitor. In addition, the dual correlated double sampling, which includes digital correlated double sampling, can be performed by using a digital circuit.

FIG. 9 is a diagram illustrating another example of the photoelectric converting unit and an example of the signal processing unit in the photo detecting apparatus of FIG. 1. In FIG. 9, the interface unit 40, the register changing unit 100, and the control register unit 200 are not illustrated for clarity.

The photo detecting apparatuses 70a, 70b, 70c performing analog-digital conversion for each column are depicted in FIG. 6, FIG. 7, and FIG. 8, respectively. A photo detecting apparatus 70d of FIG. 9 may use one analog-digital converter converting analog signal of each column to digital signal in turn

Referring FIG. 9, the photo detecting apparatus 70d includes the photoelectric converting unit 20 and a signal processing unit 30d. The signal processing unit 30d includes a row driver 31d, a correlated double sampling (CDS) unit 32d, a multiplexer 71, an analog-digital converting (ADC) unit 33d, and a timing controller 39d. The signal processing unit 30c is controlled by one of the first set value (the first register data IRWD) and the second set value (the second register data MRWD) stored in the register banks 261, 263. One of the first set value (the first register data IRWD) and the second set value (the second register data MRWD) is provided for controlling a timing controller 39d, the CDS unit 32d, and the multiplexer 71. One of the first set value (the first register data IRWD) and the second set value (the second register data MRWD) is provided as a set value (register data) according to the bus selection signal BSS.

The CDS unit 32d performs analog double sampling (ADS) by calculating difference between an analog reset voltage representing reset component and a signal component corresponding to the incident light IL. In addition, the CDS unit 32d may output an analog voltage corresponding to the effective signal component for each column. The multiplexer 71 outputs analog voltages transferred corresponding to the effective signal component. The multiplexer 71 outputs the analog voltages through the column lines. The ADC 33d converts each analog voltage to digital voltage to generate image data.

The photo detecting apparatus 70d may employ one ADC 33d to convert output signals of the plurality of columns of the pixel array. Thus, an area of the circuit may be decreased.

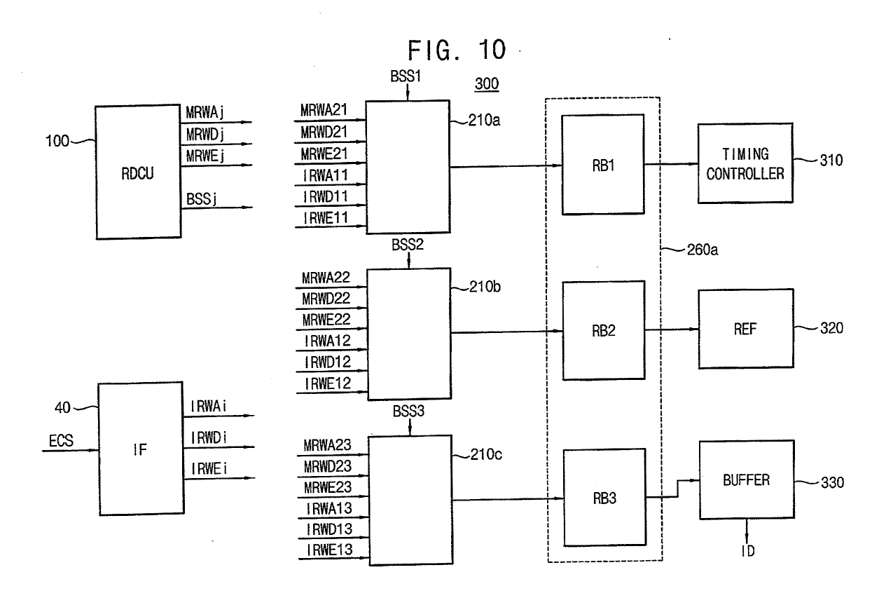

FIG. 10 is a block diagram illustrating another photo detecting apparatus according to some example embodiments. In FIG. 10, the photoelectric converting unit 20 of FIG. 1 is not illustrated for clarity. In addition, a timing controller 310, a reference voltage generator 320, and a buffer 330 are illustrated separately. Further, selection units 210a, 210b, and 210c and at least a register bank are illustrated separately in FIG. 10.

Referring FIG. 10, the interface unit 40 decodes an external control signal ECS to provide first register addresses IRWAi, first register data IRWDi, and first register enable signals IRWEi for the selection units 210a, 210b and 210c. The first register addresses IRWAi, first register data IRWDi, and first register enable signals IRWEi are associated with the first set value. The register data changing unit 100 may have a same configuration to provide second register addresses MRWAj, second register data MRWDj, and second register enable signals MRWEj for the selection units 210a, 210b and 210c. The register data changing unit 100 also provides bus selection signals BSSj for the selection units 210a, 210b, and 210c. Each of the selection units 210a, 210b, and 210c of FIG. 10, and the selection unit 210 of FIG. 4 may have a same configuration. Namely, each of the selection units 210a, 210b, and 210c may have a plurality of multiplexers.

According to a logic level of a bus selection signal BSS1, the selection unit 210a may select the first register address IRWA11 or the second register address MRWA21, the first register data IRWD11 or the second register data MRWD21, and the first register enable signal IRWE11 or the second register enable signal MRWE21. For example, when the bus selection signal BSS1 is a low level, the register bank RB1 or a register of the register bank RB1 may be activated by the first register enable signal IRWE11. In addition, the first register data IRWD11 may be stored at a location designated by the first register address IRWA11. The timing controller 310 may be controlled by the first register data IRWD11 stored in the register bank RB1.

According to a logic level of a bus selection signal BSS2, the selection unit 210b may select the first register address IRWA12 or the second register address MRWA22, the first register data IRWD12 or the second register data MRWD22, and the first register enable signal IRWE12 or the second register enable signal MRWE22. For example, when the bus selection signal BSS2 is high level, the register bank RB2 or a register of the register bank RB2 may be activated by the second register enable signal MRWE22. In addition, the second register data MRWD22 may be stored at a location designated by the second register address MRWA22. The reference signal generator 320 may be controlled by the second register data MRWD22 stored in the register bank RB2.

According to a logic level of a bus selection signal BSS3, the selection unit 210c may select the first register address IRWA13 or the second register address MRWA23, the first register data IRWD13 or the second register data MRWD23, and the first register enable signal IRWE13 or the second register enable signal MRWE23. For example, when the bus selection signal BSS3 is high level, the register bank RB3, or a register of the register bank RB3, may be activated by the second register enable signal MRWE23. In addition, the second register data MRWD23 may be stored at a location designated by the second register address MRWA23. The buffer 330 may be controlled by the second register data MRWD23 stored in the register bank RB3.

In the photo detecting apparatus of FIG. 10, the bus selection signals may have different logic levels with respect to each other. In addition, the selection units 210a, 210b and 210c may select different bus with respect to each other. Therefore, the set values for control of the timing controller 310, the reference signal generator 320, and the buffer 330 may be changed at different times each other or at the same time, e.g., sequentially or simultaneously. Namely, each of the set values of the timing controller 310, the reference signal generator 320, and the buffer 330 may be changed individually, e.g., to different values and at different times, without modification of hardware.

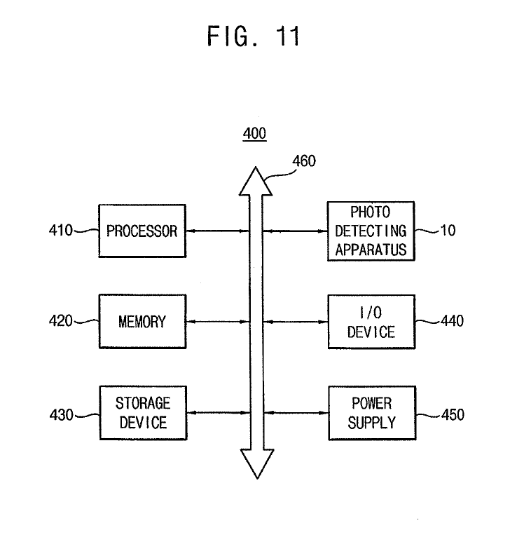

FIG. 11 is a diagram illustrating a system including the photo detecting apparatus of FIG. 1 according to some example embodiments.

Referring FIG. 11, a system 400 includes the photo detecting apparatus 10, a processor 410, a memory device 420, an I/O device 440, a storage device 430, and a power supply 450, communicating each other through a bus 460.

The processor 410 may execute various computing applications, e.g., executing certain software performing certain task. For example, the processor 410 may be a microprocessor or a central processing unit (CPU). The processor 410 may be connected to the memory device 420 through an address bus, a control bus, and/or a data bus. For example, the memory device may be many forms of non-volatile memory, including a dynamic random access memory (DRAM), a static random access memory (SRAM), an erasable programmable read-only memory (EPROM), an electrically erasable programmable read-only memory (EEPROM), and a flash memory device. The processor 410 may be connected to an extension bus such as a peripheral-component-interconnect (PCI) bus as well. With this, the processor 410 can control at least one input device, e.g., a keyboard or a mouse, at least one output device, e.g., a printer or a display module, and at least one storage device, e.g., a solid state drive, a hard disk drive, or a CD-ROM. In addition, the processor 410 may communicate with the photo detecting device 10 through the bus or other communication links. The system 400 may further include ports to communicate with a video card, a sound card, a memory card, a USB device, or other systems. In some embodiments, the photo detecting apparatus 10 integrated together with the processor 410 such as the microprocessor, the central processing unit, or a digital signal processor. The photo detecting apparatus 10 may be integrated together with the memory processor. In other embodiments, the photo detecting apparatus 10 and the processor 410 may be integrated in separate chips.

The system 400 may include the power supply 450 to provide operating voltage to other components of the system.

The system 400 may be any system using the photo detecting device, e.g. a computer, a digital camera, a 3-D camera, a mobile phone, a PDA, a scanner, a car navigator, a video phone, a surveillance system, an auto-focusing system, a tracking system, a motion-sensing system, an image-stabilization system, or the like.

The foregoing is illustrative of embodiments and is not to be construed as limiting thereof Although a few embodiments have been described, those skilled in the art will readily appreciate that many modifications are possible in the embodiments without materially departing from the novel teachings and advantages of the inventive concept. For example, although hardware implementations of embodiments have been described, components, e.g., the signal processing unit, may be implemented with software, e.g., an algorithm or firmware. The algorithm or firmware may be embodied as computer readable codes and/or programs on a computer readable recording medium. Accordingly, all such modifications are intended to be included within the scope of the inventive concept as defined in the claims.

What is claimed is:

1. A photo detecting apparatus, comprising:
a signal processing unit configured to process electrical signals converted from incident light to generate image data;
a control register unit configured to supply a set value for controlling the signal processing unit to the signal processing unit and to store a first set value supplied through a first bus, the first set value corresponding to an initial set value based on a decoded external control signal; and
a register data changing unit configured to supply a second set value to the control register unit through a second bus, separate from the first bus, when the first set value is to be changed.

2. The photo detecting apparatus as claimed in claim 1, wherein the control register unit comprises:
at least one selection unit which selects one of the first bus and the second bus in response to a bus selection signal provided from the register data changing unit; and
at least one register bank which stores one of the first set value and the second set value according to the selection of the selection unit.

3. The photo detecting apparatus as claimed in claim 2, wherein the register data changing unit comprises:
a non-volatile memory storing the second set values and commands associated with the second set values; and
a memory control circuit configured to read the commands stored in the non-volatile memory to control the non-volatile memory such that the second set value is stored in the at least one register bank of the control register unit, and configured to output the bus selection signal to the selection unit of the control register unit.

4. The photo detecting apparatus as claimed in claim 3, wherein the non-volatile memory is one of a flash memory, an Electrically Erasable Programmable Read-Only Memory(EEPROM), a Phase Change Random Access Memory(PRAM), a Resistance Random Access Memory(RRAM) and a Magnetic Random Access Memory(MRAM).

5. The photo detecting apparatus as claimed in claim 2, wherein the at least one selection unit includes a plurality of multiplexers, each multiplexer selecting:
one of a first register address associated with the first set value and a second register address associated with the second set value in response to the bus selection signal, and
one of a first register data associated with the first set value and a second register data associated with the second set value.

6. The photo detecting apparatus as claimed in claim 5, wherein the at least one register bank stores the selected data at a location designated by the selected address.

7. The photo detecting apparatus as claimed in claim 2, wherein the selection unit selects the first bus when the bus selection signal is a first level and selects the second bus when the bus selection signal is a second level.

8. The photo detecting apparatus as claimed in claim 1, wherein the control register unit comprises:
a plurality of selection units, each selection unit selecting one of the first bus and the second bus in response to a corresponding plurality of bus selection signals provided from the register data changing unit; and
a corresponding plurality of register banks, each register bank storing one of the first set value and the second set value according to the selection of a corresponding selection unit.

9. The photo detecting apparatus as claimed in claim 8, wherein the plurality of bus selection signals are sequentially applied to the plurality of selection units.

10. The photo detecting apparatus as claimed in claim 8, the plurality of bus selection signals are simultaneously applied to the plurality of selection units.

11. The photo detecting apparatus as claimed in claim 8, wherein the plurality of bus selection signals are independently generated.

12. The photo detecting apparatus as claimed in claim 11, each selection unit provides one of the first set value and the second set value in response to a corresponding plurality of bus selection signals to different components of the signal processing unit.

13. A system, comprising:
a processor; and
a photo detecting apparatus in communication with the processor, the photo detecting apparatus comprising:
a signal processing unit configured to process electric signals converted from incident light to generate image data;
a control register unit configured to supply a set value for controlling the signal processing unit to the signal processing unit and to store a first set value supplied through a first bus, the first set value corresponding to an initial set value based on a decoded external control signal; and
a register data changing unit configured to supply a second set value to the control register unit through a second bus, separate from the first bus, when the first set value is to be changed.

14. The system as claimed in claim 13, wherein the signal processing unit includes an analog double sampling unit configured to calculate a difference between an analog reset voltage and an analog data voltage, the analog reset voltage representing a reset component and the analog data voltage representing a signal corresponding to the incident light.

15. The system as claimed in claim 14, wherein the photo detecting apparatus includes a pixel array and the signal processing unit is configured to perform analog-digital conversion for each column of the pixel array.

16. The system as claimed in claim 13, wherein the signal processing unit includes:
an analog to digital converting unit configured to convert an analog signal associated with a reset component and an analog signal associated with a signal component into two digital signals, respectively; and
a digital double sampling unit configured to calculate a difference between the two digital signals.

17. The system as claimed in claim 16, wherein the photo detecting apparatus includes a pixel array and the analog to digital converting unit is configured to converts analog signals for each column of the pixel array.

18. The system as claimed in claim 13, wherein the photo detecting apparatus includes a pixel array and the signal processing unit comprises:
a correlated double sampling unit configured to perform an analog double sampling on an analog reset voltage representing a reset component and an analog data voltage representing a signal corresponding to the incident light for calculating a difference between the analog reset voltage and the analog data voltage, and configured to output an analog voltage corresponding to an effective signal component for each column of the pixel array;
a multiplexer which sequentially outputs the analog voltage corresponding to the effective signal component for each column of the pixel array; and
an analog-digital converting unit configured to convert an output of the multiplexer into a digital voltage.

19. A control system for use with a photo detecting apparatus, the control system comprising:
a controller configured to provide a set value to a signal processing unit that processes electrical signals converted from incident light to generate image data, the signal processing unit operating in accordance with the set value;
a first bus through which a first set value corresponding to an initial set value based on a decoded external control signal is supplied to the controller; and
a second bus, separate from the first bus, through which a second set value, different from the first set value, is supplied to the controller.

20. The control system as claimed in claim 19, wherein the controller comprises at least one selection unit which provides one of the first set value and the second set value to the signal processing unit in response to a bus selection signal.
